(19) United States
(12) Patent Application Publication
(10) Pub. No.: US 2006/0077876 A1
(43) Pub. Date: Apr. 13, 2006

(54) Optical recording media and method of fabricating the same

(75) Inventors: Chia-Sheng Lin, Kaohsiung County (TW); Rei-Feng Chung, Miaoli County (TW); Hsiang-Ling Huang, Taipei County (TW)

Correspondence Address: BIRCH STEWART KOLASCH & BIRCH, PO BOX 747, FALLS CHURCH, VA, 22040-0747, US

(73) Assignee: Daxon Technology Inc., Taoyuan (TW)

(21) Appl. No.: 11/221,782

(22) Filed: Sep. 9, 2005

(30) Foreign Application Priority Data
Sep. 10, 2004 (CN) 93127444

(51) Int. Cl. G11B 7/24

(52) U.S. Cl. 369/275.1; 369/283

(57) ABSTRACT

A recording medium. A recording layer is disposed overlying a substrate. A moisture barrier layer is disposed overlying the recording layer. A reflecting layer is disposed overlying the moisture barrier layer. An adhesion layer is disposed overlying the reflecting layer. Due to the static moisture barrier layer interposed between the reflecting layer and the recording layer in an embodiment of the invention, moisture interpenetration from ambience can be diminished to improve weather and corrosion resistance of the recording medium.

### BACKGROUND

The invention relates to optical recording media and method of fabricating the same, and in particular to an optical recording disk and method of fabricating the same.

Due to requirements for large data of digital videos, capacity of recordable compact disk (CD-R) is not enough. Digital versatile disks (DVD) become a preferred optical recording medium.

In the recordable compact disk CD-R and the digital versatile disk DVD manufacturing process, substrates are formed by injection molding with stampers carved with grooves. FIG. 1 shows a recording one time digital versatile disk. As shown in FIG. 1, a recording layer 102 is formed on the substrate 100 by spin coating. The thickness of the recording layer 102 is about 50 nm˜200 nm. A reflecting layer 104 is formed on the recording layer 102 by sputtering. An adhesion layer 106 is coated on the recording layer 104. A top plate 101 is bonded to the reflecting layer 104 through the adhesion layer 106. Dyes are spin coated on the substrate uniformly to form the recording layer 102, in which the quantity of the dyes in the grooves and on the lands is tuned to control Ld therebetween. Signals of the disk can be controlled according to Ld. Consequently, spin coating of dyes is an important factor in a recording media manufacturing process and can affect the quality thereof.

As shown in FIG. 1, the purpose of forming the reflecting layer 104 on a recording layer 102 in the recording one time digital versatile disk manufacturing process, including DVD+R and DVD-R, is to increase reflectivity. In addition, the reflecting layer 104 can increase lifetime of the recording media. Typically, the reflecting layer 104 of the recording one time digital versatile disk is formed of silver or silver alloy. Although recording one time digital versatile disks using the reflecting layer 104 formed of silver alloy present good performance, they incur increased cost, and the recording layer 102 formed of silver is easily damaged, creating a rough surface or can be deformed by moisture. Additionally, the dyes of the recording layer 102 are typically water-absorbent, with moisture therein easily infiltrating the reflecting layer 104 to affect performance of the recording media.

### SUMMARY

An embodiment of the invention provides a recording medium. A recording layer is disposed overlying a substrate. A moisture barrier layer is disposed overlying the recording layer. A reflecting layer is disposed overlying the moisture barrier layer. An adhesion layer is disposed overlying the reflecting layer.

An embodiment of the invention provides a method for forming a recording medium. A substrate is provided. A recording layer is coated overlying the substrate, the recording layer of organic dye. A moisture barrier layer is formed overlying the recording layer. A reflecting layer is formed overlying the moisture barrier layer. An adhesion layer is formed overlying the reflecting layer. A top plate is bonded to the reflecting layer by the adhesion layer.

### BRIEF DESCRIPTION OF THE DRAWINGS

The invention can be more fully understood by reading the subsequent detailed description and examples with references made to the accompanying drawings, wherein:

FIG. 1 shows a recording one time digital versatile disk.

FIG. 2 shows a recording one time digital versatile disk of an embodiment of the invention.

FIG. 3 shows a recording one time CD.

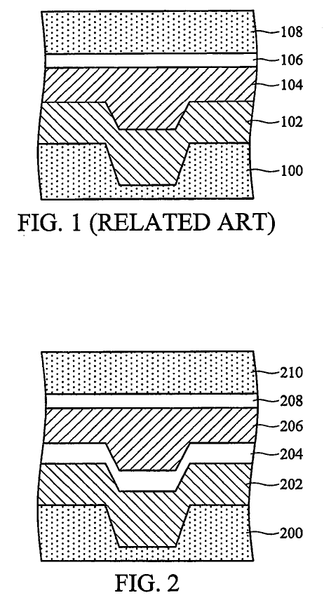

### DETAILED DESCRIPTION OF THE INVENTION

FIG. 2 shows a recording one time digital versatile disk of an embodiment of the invention. The recording one time digital versatile disk can be DVD+R or DVD-R. A substrate 200 is provided. In a preferred embodiment of the invention, the substrate 200 comprises polymer, and preferably polycarbonate or PMMA.

Next, a recording layer 202 is formed on the substrate 200. The recording layer 202 can comprise absorbent organic solvent TFP and dye, and be formed on the substrate 200 by spin coating. A moisture barrier layer 204 is formed on the recording layer 202 by, for example, reactive sputtering. In a preferred embodiment, the moisture barrier layer 204 comprises ceramic, which is static and provides higher transmittance. Ceramic can comprises oxide or nitride. The oxide can comprise but not limited to SiO, SiO₂, Al₂O₃, MoO₃, TeO₂, Pb₂O₃, Cu₂O, Bi₂O₃, ZrO₂, ZnO₂, Ta₂O₅, ZnS—SiO₂ or the combination thereof. The nitride can comprises SnN, ZnN, PbN, BiN, TiN, SN, GeN, CdN, SiN, AlN, SnN, InN, CuN, CoN, MoN, IN or the combination thereof.

In a more preferred embodiment of the invention, the moisture barrier layer 204 is formed of Al₂O₃ by reactive sputtering on the recording layer 202. The reactive sputtering for forming the moisture barrier layer 204 can comprise the following steps. An aluminum target is setup in a chamber with low pressure, such as about 10-6˜10-9 Torr. Ar and N₂ are introduced into the chamber to sputter the aluminum target, in which N₂, N or N ions may react with Al atoms or ions to form aluminum nitride on the recording layer 202. According to inspection of atomic force microscopy AFM, the reflecting layer has a roughness less than about 50 μm.

Next, a reflecting layer 206 is formed on the moisture barrier layer 204 by, for example sputtering. In an embodiment, the reflecting layer 206 has a high reflecting coefficient and comprises non-expensive metals, such as silver. In a preferred embodiment of the invention, the reflecting layer 206 comprises silver, and more preferably has a thickness of about 70 nm˜80 nm to present reflectivity acceptable for the optical recording. An adhesion layer 208 is formed on the reflecting layer 206 by spin coating, and a top plate 210 bonded to the reflecting layer 206 through the adhesion layer 208.

Please refers to FIG. 2, an optical recording medium of an embodiment of the invention is illustrated. A recording layer 202, comprising organic dyes, is disposed on the substrate 200. A moisture barrier layer 204 is disposed on the recording layer 202. A reflecting layer 206 is disposed on the moisture barrier layer 204. An adhesion layer 208 is disposed on the reflecting layer 206, wherein the adhesion layer 208 can be formed by coating and hardening polymer.

Due to the static moisture barrier layer 204 interposed between the reflecting layer 206 and the recording layer 202 in an embodiment of the invention, moisture interpenetration from ambience can be diminished to improve weather and corrosion resistance of the recording medium. In addition, due to the protection of the moisture barrier layer 204 in an embodiment of the invention, silver, a non-expensive material, can be used as the reflecting layer 206 to reduce cost of the recording medium.

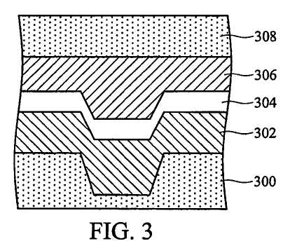

The moisture barrier layer can be interposed between an absorbent recording layer and a reflecting layer in any recording medium. FIG. 3 shows a recording one time CD (CDR). The CDR includes a substrate 300, a recording layer 302, a reflecting layer 306 and a protective layer 308 in order. The moisture barrier layer 304 of the invention can be interposed between the reflecting layer 306 and the recording layer 302 of the CDR.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A recording medium, comprising:
a substrate;
a recording layer overlying the substrate;
a moisture barrier layer overlying the recording layer;
a reflecting layer overlying the moisture barrier layer; and
an adhesion layer overlying the reflecting layer.

2. The recording medium as claimed in claim 1, wherein the moisture barrier layer is ceramic.

3. The recording medium as claimed in claim 2, wherein the ceramic is aluminum nitride.

4. The recording medium as claimed in claim 1, wherein the reflecting layer is silver.

5. The recording medium as claimed in claim 1, wherein the reflecting layer is silver alloy.

6. The recording medium as claimed in claim 1, wherein the reflecting layer has a roughness less than 50 μm.

7. A recording medium, comprising:
a substrate;
a recording layer overlying the substrate, wherein the recording layer is formed of organic dye;
a moisture barrier layer overlying the recording layer, wherein the moisture barrier layer is formed of aluminum nitride;
a reflecting layer overlying the moisture barrier layer, wherein the reflecting layer is formed of silver;
an adhesion layer overlying the reflecting layer; and
a top plate overlying the adhesion layer.

8. A method for forming a recording medium, comprising:
providing a substrate;
coating a recording layer overlying the substrate wherein the recording layer is formed of organic dye;
forming a moisture barrier layer overlying the recording layer;
forming a reflecting layer overlying the moisture barrier layer;
forming an adhesion layer overlying the reflecting layer; and
providing a top plate, bonded to the reflecting layer by the adhesion layer.

9. The method for forming a recording medium as claimed in claim 8, wherein the moisture barrier layer is ceramic.

10. A method for forming a recording medium as claimed in claim 9, wherein the ceramic is aluminum nitride.

11. The method for forming a recording medium as claimed in claim 8, wherein the reflecting layer is formed of silver.

12. The method for forming a recording medium as claimed in claim 8, wherein the reflecting layer is formed of silver alloy.

13. The method for forming a recording medium as claimed in claim 8, wherein the reflecting layer has a roughness less than 50 μm.

14. The method for forming a recording medium as claimed in claim 8, wherein the moisture barrier layer is formed overlying the recording layer by reactive sputtering.
